(19) United States
(12) Patent Application Publication
(10) Pub. No.: US 2025/0202166 A1
(43) Pub. Date: Jun. 19, 2025

(54) SHIELDED PUSH-PULL PLUG HAVING SHIELDING SPRING

(71) Applicant: BELDEN DEUTSCHLAND GMBH, Schalksmühle (DE)

(72) Inventor: Jan DERBOGEN, Rottenburg (DE)

(73) Assignee: BELDEN DEUTSCHLAND GMBH, Schalksmühle (DE)

(21) Appl. No.: 18/847,027

(22) PCT Filed: Mar. 10, 2023
(86) PCT No.: PCT/EP2023/056154

§ 371 Date: Sep. 13, 2024

(30) Foreign Application Priority Data
Mar. 14, 2022 (DE) 102022105902.2

(51) Int. Cl. H01R 13/6583

(52) U.S. Cl. CPC H01R 13/6583

(57) ABSTRACT

A push-pull plug may include a shielding spring which, viewed in the insertion direction, may have tab-like projections at the front, wherein a snap-ring may have tab-like recesses which correspond to the tab-like projections of the shielding spring and in which the projections of the shielding spring are arranged so that the tab-like projections of the shielding spring together with the tab-like projections of the snap-ring form a completely circumferential projection which comes to bear in the undercut in the panel-mounted socket. In the process, the shielding spring, which may be made of a metal material, loops through the shielding of the push-pull plug to the panel-mounted socket, wherein the shielding spring is directly or indirectly electrically connected to a shielding of a cable on which the push-pull plug is arranged.

The invention relates to a shielded push-pull plug which can be plugged into a panel-mounted socket (also referred to as an installation coupling, depending on the configuration) and thereby latches, in accordance with the features of the general terms of the two independent patent claims.

A known shielded push-pull plug has a contact carrier which has at least one contact chamber into which a mating contact partner is inserted. A shielding sleeve made of an electrically conductive material is arranged around the contact carrier. A snap-ring is arranged around the shielding sleeve, which snap-ring has a completely circumferential projection pointing forwards in the insertion direction (in the direction of the connector face), which projection can be brought into operative connection with an undercut of the panel-mounted socket (generally and hereinafter also referred to as a mating plug) when the push-pull plug is plugged into the panel-mounted socket. A grip sleeve (hereinafter also referred to as a female) is arranged around the snap-ring, with which the snap-ring can be actuated when the push-pull plug is to be pulled out of the panel-mounted socket, wherein by an axial movement of the grip sleeve, its front end acts on a circumferential sloping ramp of the snap-ring and thereby presses it down, as a result of which the completely circumferential projection of the snap-ring is pressed down and thereby moved out of the undercut of the panel-mounted socket. A further axial displacement of the grip sleeve causes the push-pull plug to be pulled completely out of the panel-mounted socket.

The invention is based on the task of improving the shielding properties of a known shielded push-pull plug.

This task is solved according to a first concept, in that a shielding spring is provided which, viewed in the insertion direction, has tab-like (tongue-shaped) projections at the front wherein the snap-ring has tab-like recesses which correspond to the tab-like projections of the shielding spring and in which recesses the projections of the shielding spring are arranged (engage) so that the tab-like projections of the shielding spring together with the tab-like projections of the snap-ring form a completely circumferential projection, which comes to bear in the undercut of the panel-mounted socket, and the shielding spring, which is made of a metal material, loops through the shielding of the push-pull plug to the panel-mounted socket. At the same time, the shielding spring is directly or indirectly electrically connected to the shielding of the cable on which the push-pull plug is arranged.

In a further development of the invention, it is provided that the tab-like projections emanate from a cylindrical main body of the shielding spring. By means of the main body, the shielding spring can be designed in such a way that it bears against both the snap-ring and the shielding sleeve or alternatively between partial areas of these two elements. In this way, under spring action, a mechanical arrangement and fixing as well as alternatively or additionally an electrical mating between the snap-ring (if made of a metal material) and the shielding sleeve (if likewise made of a metal material) can be realized. Alternatively, the shielding spring can be arranged between the shielding sleeve and the female, at least with partial areas.

In a further development of the invention, it is provided that the main body has a slot running parallel to the longitudinal axis of the shielding sleeve. As a result, the main body has a spring effect when it is arranged and fixed at its installation location. As a result, on the one hand it is fixed and on the other hand, under spring action, it can permanently realize the electrical mating.

In a further development of the invention, it is provided that at least one approximately U-shaped spring element (bend) emanates from the main body. The at least one approximately U-shaped spring element (or more than one such element distributed around the circumference of the main body) increases the spring effect. On the other hand, tolerances can be compensated. An adjustment of the shielding spring can, moreover, take place in its installation space between the snap-ring (or possibly also the female) and the shielding sleeve, in particular under spring action.

In a further development of the invention, it is provided that at least one locking tab is formed by the main body. Using this at least one locking tab, preferably a plurality of locking tabs distributed over the circumference of the main body, the shielding spring can be fixed in its installation space on the elements involved, elements such as the snap-ring, the female, and/or the shielding sleeve. For this purpose, these elements can have corresponding geometries, such as depressions, circumferential grooves or the like, into which the at least one locking tab engages when the shielding spring has been arranged at its installation location as intended.

According to a second concept, the problem is solved in that in the front area of the push-pull plug, in particular in its snap-ring, a spring washer is inserted which interacts there, after the push-pull plug has been inserted into the panel-mounted socket, with its undercut, in particular with a groove, wherein the spring washer has a circumferentially undulating design.

Further configurations of this second concept with the spring washer are described in connection with the associated figures.

Embodiment examples of the two concepts shown above are shown and described below.

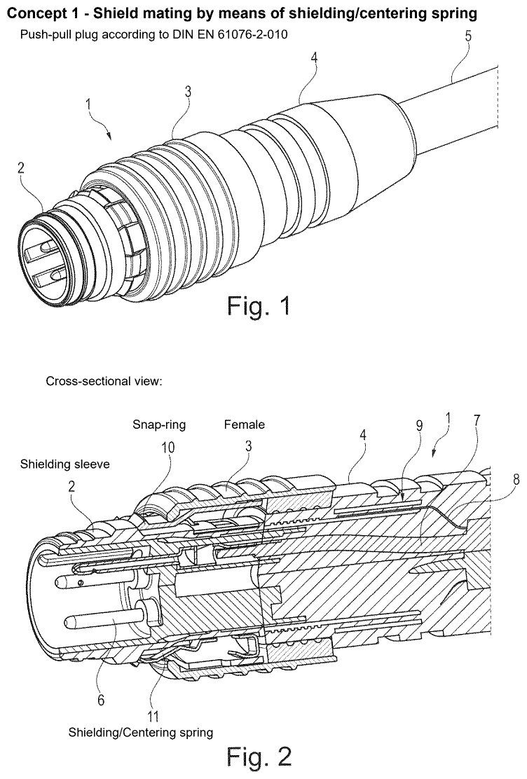

A plug 1 according to the first concept of the invention is shown in FIG. 1 to FIG. 7.

The plug 1 according to FIG. 1 has a shielding sleeve 2, wherein a female 3 that can be moved, in particular displaced, relative to the shielding sleeve 2, is arranged over a partial area of the shielding sleeve 2. A further housing-like element of the plug 1, in particular an overmolding 4, is provided behind one end of the female 3. A shielded cable 5 emerges from this element, in particular from the overmolding 4.

A cross-sectional view of the plug 1 is shown in FIG. 2. Contacts 6, which are arranged in unspecified contact chambers of a contact carrier which is arranged inside the shielding sleeve 2, are also recognizable. An electrical conductor 7, or more precisely its stripped front end, of the cable 5 is connected to the contact 6. The plug 1 has at least one contact 6, but usually a plurality of contacts 6 and corresponding electrical conductors 7. The reference number 8 indicates a shielding of the cable 5, which is connected and is electrically mated in a connection area 9 with the shielding sleeve 2, which is made of an electrically conductive material. A snap-ring 10 for realizing the push-pull connection with a mating plug is arranged inside the female 3 and with its front end overlapping a partial area of the shielding sleeve 2. A shielding spring, which is arranged around the shielding sleeve 2 and which is also made of an electrically conductive material, is provided with the reference number 11.

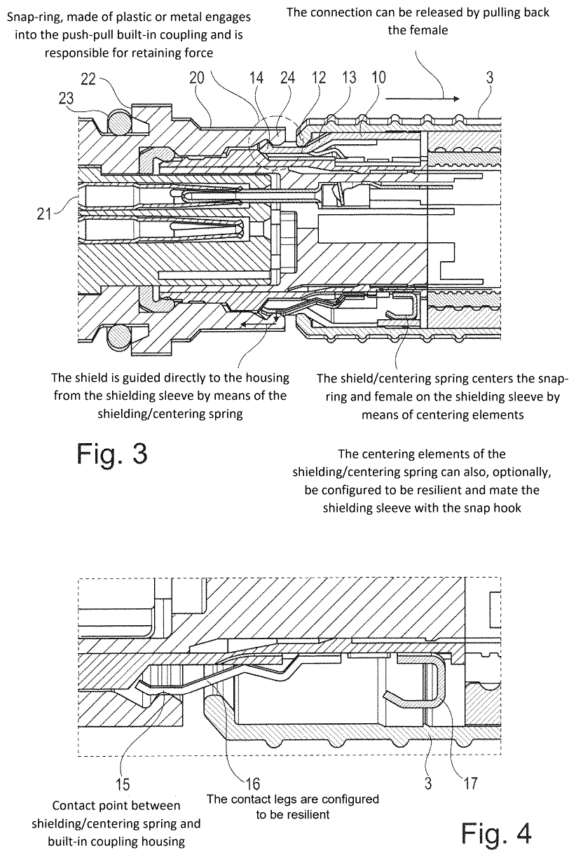

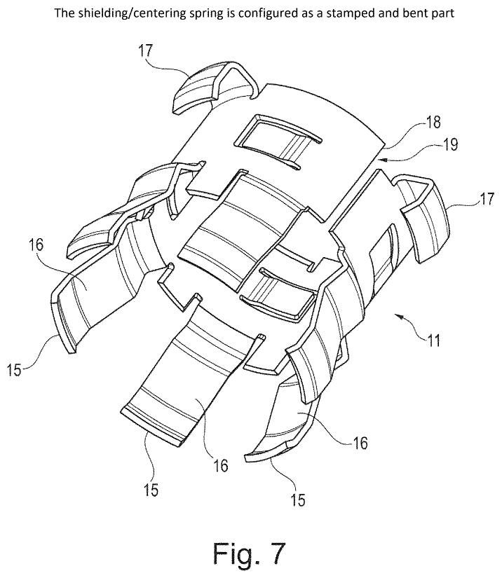

FIG. 3 shows the plug 1, which is plugged together with a mating plug. A front end 12 of the female 3 is approximately angled and lies on a ramp 13 of the snap-ring 10. A front locking tab 14 of the snap-ring 10 is in operative connection with a housing 20 of the mating plug. The housing 20 accommodates contacts 21 of the mating plug, which are plugged together with the contacts 6 of the plug 1. The housing 20, moreover, for example, has a circumferential frame 22, in the area of which a circumferential seal 23 is arranged. The housing 20 is inserted into an opening not shown, for example, into an electronic device, where it is fixed in a sealing manner by means of the seal 23. As an alternative to the panel-mounted socket, the mating plug can also be arranged at the end of a cable. The housing 20 has an engagement-like projection 24, which forms an undercut for the front locking tabs 14 of the snap-ring 10. The snap-ring 10, made of plastic or metal, engages into the mating plug (also referred to as built-in coupling) and is responsible for the retaining force of the plug connection. The shielding is conducted from the shielding sleeve 2 by means of the shielding spring 11 directly to the housing 20 of the mating plug (see the representation in the lower area of the plug 1 in FIG. 3). The shielding spring 11 centers the snap-ring 10 and the female 3 on the shielding sleeve 2 and has corresponding centering elements (see FIG. 7). The centering elements of the shielding spring 11 can also, optionally, be configured to be resilient and mate the shielding sleeve 2 with the snap hook.

As can be seen in FIG. 3, the plug connection consisting of plug 1 and the mating plug that are plugged together can, once again, be released by actuating the female 3. When the female 3 is pulled backwards (to the right when looking at FIG. 3), the ramp 13 is actuated by the front angled end 12 of the female 3, whereby the front end 14 of the snap-ring 3 is moved (deflected) downwards, so that this front end 14 is no longer in the area of the undercut 24 of the housing 20 of the mating plug. The plug 1 can thereby be pulled out of the mating plug with only slight force after the female 3 has been moved. Conversely, this means that when plugging together, the front end 14 of the snap-ring 10 is brought into the undercut geometry by means of the front end 24 of the housing 20, inasmuch as the front end of the snap-ring 10 is deflected slightly in the direction of the longitudinal axis of the plug 1 by means of the ramp 13 and, after the plugging process has been completed, the undercut, formed by the front end 24 of the housing 20, engages behind it in such a way that the plug connection can no longer be thrust apart without actuating the female 3. This is also known as a push-pull process.

The area around the shielding spring 11 is shown in detail in FIG. 4. It can be seen that the front end of the shielding spring 11 forms a contact point 15 between the shielding spring 11 and the housing 20 of the mating plug (the built-in coupling). In order for this front area of the shielding spring 11 to bear permanently against the housing 20, the contact legs (tab-like projections 16) of the shielding spring 11 are configured to be resilient. There is, moreover, an approximately U-shaped bend 17 in the end area of the shielding spring 11. As seen in FIG. 4, the lower horizontal leg of this bend 17 is not free-floating when the plug 1 is realized, but rather a partial area of the snap-ring 10 (as can be seen in FIG. 3) is arranged between the lower horizontal leg and the inner contour of the female 3.

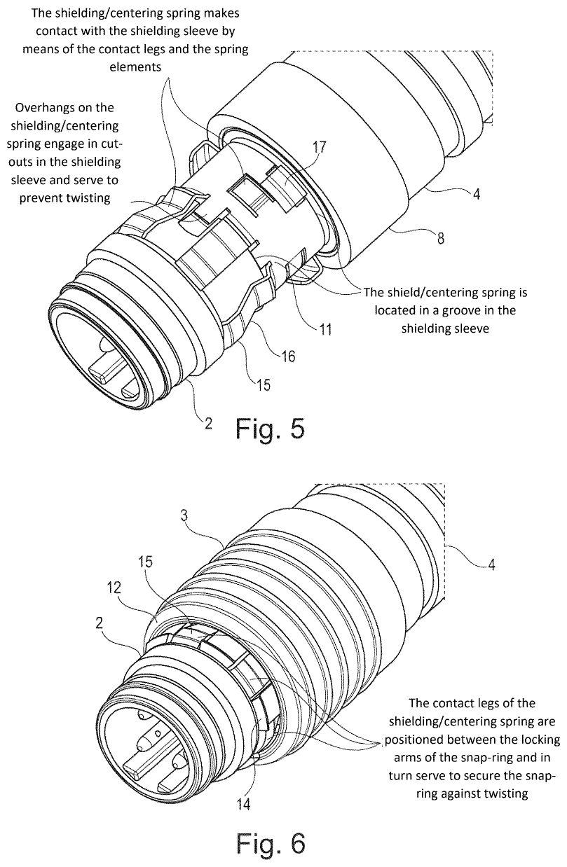

FIG. 5 shows the inner workings of the plug 1, in which the shielding spring 11 is arranged on the rear area of the shielding sleeve 2. The shielding spring 11 mates with the shielding sleeve 2 by means of its contact leg 16 and of the spring elements. Overhangs, which protrude forwards, on the shielding spring 11 engage in cut-outs in the shielding sleeve 2 and serve to secure the shielding spring 11 against twisting. The shielding spring 11, with its main body, is located in a groove (or alternatively a set back section with a smaller diameter) in the shielding sleeve 2, which is to say more precisely, the shielding spring 11 is arranged with its main body over this smaller-diameter section of the shielding sleeve 2.

The plug 1 after the fitting of the female 3 is shown in FIG. 6. It can thereby be seen that the front end of the shielding sleeve 2 remains free. Behind it and before the start of the front end of the female 3, one can see the front locking tabs of the snap-ring 10 and the contact leg 16 of the shielding spring 11. These last two elements are distributed alternatingly around the circumference. The contact leg 16 of the shielding spring 11 are thereby positioned between the locking arms (front end 14 of the snap-ring 10) and in turn serve to secure the snap-ring 10 against twisting.

The shielding spring 11 is shown in detail in FIG. 7. Here too, the front ends of the tab-like projections, which form the contact points 15, can be seen, which are arranged on the contact legs 16. The U-shaped elements (bends 17) can, moreover, be seen. Each contact leg 16 protrudes from a main body 18 of the shielding spring 11, as do the bends 17. In this embodiment example, the main body 18 is configured in a roughly cylindrical shape, however, having said this, it is interrupted in its circumferential course by a slot 19 to realize a spring effect. Alternatively, the main body 18 can also have a closed circumference. Locking tabs that are not further specified are, moreover, arranged in the main body 18.

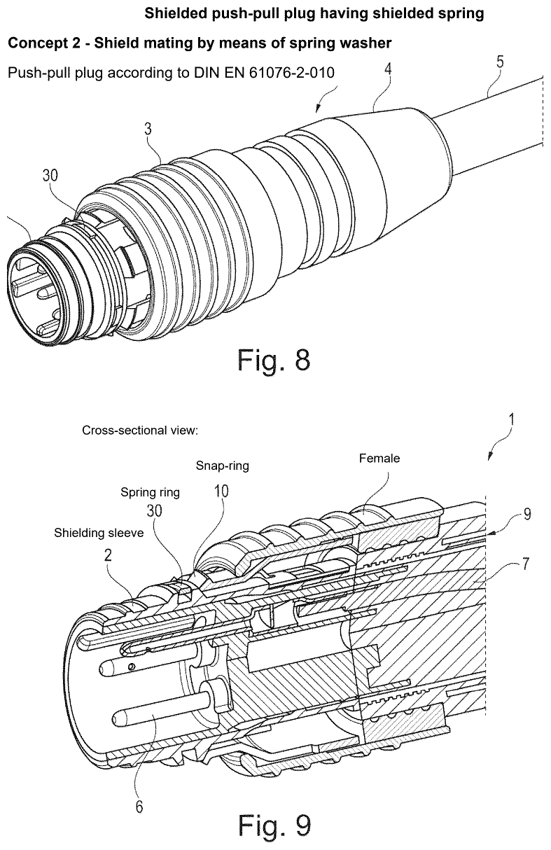

A plug 1 according to the second concept of the invention is shown in FIG. 8 through FIG. 11. Identical elements for both concepts are provided with the same reference numbers. The plugging principle according to the push-pull process is, moreover, the same for both concepts, so that the same elements with the same function as the plug 1 according to the first concept are used for the plug 1 according to the second concept.

The difference of the plug 1 according to the second concept is directly recognizable in FIG. 8 and FIG. 9. A spring washer 30 is thereby arranged in the front area of the plug 1 or on the shielding sleeve 2. This spring washer 30 is electrically connected to the shielding 9 of the cable 5 by means of the shielding sleeve 2 made of a metal material.

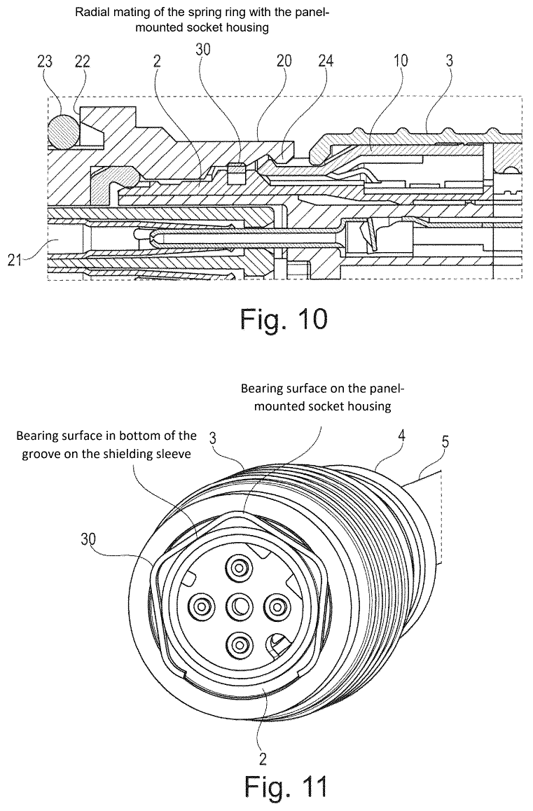

Looking at FIG. 10, it can be seen that the spring washer 30 comes to bear on the inner contour of the housing 20 of the mating plug when the plug 1 is plugged into the mating plug and locked by means of the snap-ring 10. Here too, the snap-ring 10, or more precisely its front end, can be actuated by moving the female 3 so that the undercut geometry in the front end 24 of the mating plug is released and an extraction of the plug 1 from the mating plug is possible.

FIG. 11 shows the plug 1 according to the second concept with a view of its connector face, wherein, among other things, it can be seen that the contacts are arranged in a contact carrier, wherein the contact carrier is arranged inside the shielding sleeve 2 (and also in the further course inside the snap-ring 10 and thereby also inside the female 3). It can, moreover, be seen that the spring washer 30 is approximately wave-shaped. The spring washer 30, together with a respective trough, rests on its associated bearing surface on the shielding sleeve 2, in particular in the bottom of a groove in the shielding sleeve 2, and forms a contact point there. The high points of the spring washer 30 next to the respective trough form bearing surfaces, or more precisely contact points, of the spring washer 30 in the direction of the inner contour of the housing 20 of the mating plug. Thus, in the plugged in state, the spring washer 30 causes electrical mating from the shielding 9 of the cable 5 in the direction of the shielding of the mating plug, inasmuch as the spring washer 30 comes to bear electrically with the housing 20 made of a metal material of the mating plug.

### LIST OF REFERENCE SIGNS

1. Plug
2. Shielding sleeve
3. Female (grip sleeve)
4. Overmolding
5. Cable
6. Contact
7. Electrical conductor
8. Shielding
9. Connection area
10. Snap-ring
11. Shielding spring
12. Front end
13. Ramp
14. Front end
15. Tab-like projection (contact point)
16. Tab-like projection (contact leg)
17. Bend
18. Main body
19. Slot
20. Housing
21. Contact
22. Circumferential frame
23. Seal
24. Front end
30. Spring washer

1.-11. (canceled)

12. A shielded push-pull plug comprising:
a contact carrier which has at least one contact chamber into which a mating contact partner is inserted;
a shielding sleeve made of an electrically conductive material and arranged around the contact carrier;
a snap-ring arranged around the shielding sleeve, which snap-ring has a completely circumferential projection pointing forwards in the insertion direction, which projection can be brought into operative connection with an undercut of a panel-mounted socket;
a grip sleeve arranged around the snap-ring, with which the snap-ring can be actuated when the push-pull plug is to be pulled out of the panel-mounted socket, wherein by an axial movement of the grip sleeve, its front end acts on a circumferential sloping ramp of the snap-ring and thereby presses it down, wherein the completely circumferential projection of the snap-ring is pressed down and thereby moved out of the undercut of the panel-mounted socket, wherein a further axial displacement of the grip sleeve causes the push-pull plug to be pulled completely out of the panel-mounted socket;
a shielding spring, which, viewed in the insertion direction, has tab-like projections at the front;
wherein the snap-ring has tab-like recesses which correspond to the tab-like projections of the shielding spring and in which the projections of the shielding spring are arranged so that the tab-like projections of the shielding spring together with the tab-like projections of the snap-ring form a completely circumferential projection which comes to bear in the undercut in the panel-mounted socket, and, in the process, the shielding spring, which is made of a metal material, loops through the shielding of the push-pull plug to the panel-mounted socket; and
wherein the shielding spring is directly or indirectly electrically connected to a shielding of a cable on which the push-pull plug is arranged.

13. The shielded push-pull plug of claim 12, wherein the tab-like projections emanate from a cylindrical main body of the shielding spring.

14. The shielded push-pull plug of claim 13, wherein the main body has a slot running parallel to the longitudinal axis of the shielding sleeve.

15. The shielded push-pull plug of claim 13, wherein at least one approximately U-shaped spring element emanates from the main body.

16. The shielded push-pull plug of claim 13, wherein at least one locking tab is formed by the main body.

17. A shielded push-pull plug comprising:
a contact carrier which has at least one contact chamber into which a mating contact partner is inserted;
a shielding sleeve made of an electrically conductive material arranged around the contact carrier;
a snap-ring arranged around the shielding sleeve, which snap-ring has a completely circumferential projection pointing forwards in the insertion direction, which projection can be brought into operative connection with an undercut of a panel-mounted socket;
a grip sleeve arranged around the snap-ring, with which the snap-ring can be actuated when the push-pull plug is to be pulled out of the panel-mounted socket, wherein by an axial movement of the grip sleeve, its front end acts on a circumferential sloping ramp of the snap-ring and thereby presses it down, wherein the completely circumferential projection of the snap-ring is pressed down and thereby moved out of the undercut of the panel-mounted socket, wherein a further axial displacement of the grip sleeve causes the push-pull plug to be pulled completely out of the panel-mounted socket;
a spring washer disposed in the front region of the push-pull plug and configured to interact there, after the push-pull plug has been inserted into the panel-mounted socket, with its undercut; and
wherein the spring washer has a circumferentially undulating design.

18. The shielded push-pull plug of claim 17, wherein the spring washer (30) is arranged in the snap-ring (10).

19. The shielded push-pull plug of claim 17, wherein the spring washer is arranged in the shielding sleeve.

20. The shielded push-pull plug of claim 17, wherein the undercut of the panel-mounted socket is a groove.

21. The shielded push-pull plug of claim 17, wherein the spring washer is circumferentially closed.

22. The shielded push-pull plug of claim 17, wherein the spring washer is circumferentially interrupted.
